(19) United States
(12) Patent Application Publication
(10) Pub. No.: US 2005/0149847 A1
(43) Pub. Date: Jul. 7, 2005

(54) Monitoring system for general-purpose computers

(76) Inventor: Richard M. Chandler, Reading (GB)

Correspondence Address: COLLIER SHANNON SCOTT, PLLC, 3050 K STREET, NW, SUITE 400, WASHINGTON, DC, 20007, US

(21) Appl. No.: 10/976,301

(22) Filed: Oct. 29, 2004

Related U.S. Application Data
(63) Continuation of application No. PCT/GB03/01869, filed on May 1, 2003.

(30) Foreign Application Priority Data
May 3, 2002 (GB) 0210242.4

(51) Int. Cl. G06F 17/00; G06F 15/173

(52) U.S. Cl. 715/500; 715/513; 709/224; 715/530

(57) ABSTRACT

Computer monitoring system and corresponding processes. One example provides a host data processing module; adaptively updates the host module with one or more additional data processing modules; and processes a document comprising a plurality of separate data portions, said data portions being intended for processing by different data processing modules, the document processing comprising parsing the document in accordance with a plurality of rules so as to validate the document, wherein the method comprises retrieving a subset of rules, in respect of at least one said data processing module, and building said plurality of rules from said subset. The present invention therefore provides a method of carrying out processing of documents using an adaptable set of data processing modules which act on different portions of the document. A single document can then be sent and/or stored on behalf of and/or processed by the plurality of data processing modules, thereby increasing efficiency of processing and network resource utilisation.

### CROSS REFERENCE TO RELATED APPLICATIONS

This application is a continuation of International Application No. PCT/GBO3/01869, filed May 1, 2003, entitled “Monitoring System for General Purpose Computers”, which claims priority under 35 U.S.C. 119 to Great Britain Application No. 0210242.4, filed May 3, 2002, entitled “Updating a Monitoring Agent Using a Structured Document.” The entire contents of these applications are hereby incorporated by reference.

### FIELD OF THE INVENTION

This invention relates to a monitoring system for general-purpose computers, such as computer workstations and servers, connected via a data communications network to common resources.

### BACKGROUND

In a typical private computer network, a plurality of computer workstations will be connected to common resources in the network. The workstations may be ones themselves having a fully operative application execution environment, such as a conventional personal computer running applications on a native operating system, such as Microsoft Windows™, or may be thin client computers using the resources of a network server, such as a Citrix™ server, to run application sessions on their behalf. Typically, a network manager will be tasked with ensuring that both the hardware and software resources within the network are operating correctly, being used effectively, and within a set of more or less formal rules for network resource utilisation. Network resource utilisation may for example be monitored to ensure that the appropriate software licences are in place and that unauthorised software is not being used on the network. It is useful to a network manager to be able to monitor network resource utilisation from a remote terminal, without having to monitor the activities at each workstation separately.

Systems for remotely monitoring network resource utilisation are known. U.S. Pat. No. 5,987,135 describes a system and method for controlling and monitoring remote distributed processing systems from one or more control processing systems by downloading agent-application programs from the control processing systems to remote control middleware modules on the distributed processing systems, where the control processing systems have a library of available agent-applications for carrying out various monitoring and control tasks, such as determining which applications are run, determine the version of installed software and current software fixes, etc.

In known systems, monitoring is typically carried out repeatedly and continually on the network. Depending on the type and frequency of monitoring carried out, the amount of data generated and resources used can be relatively large. As a result there is often a conflict between, on the one hand, a need to reduce the amount of monitoring carried out in order to reduce the impact on network resources to an acceptable level, and on the other hand, a need to gather monitoring data at regular intervals in order to generate an accurate and complete assessment of network resource utilisation.

It would be desirable to provide a network resource utilisation monitoring system that has the ability to collect and process large amounts of data in a secure and reliable fashion whilst reducing the impact on network resources. It would also be desirable to provide such a system having the capability to add new monitoring functions with relative ease and reliability. Preferably, the system should be adaptable such that generic monitoring and control functions are provided by such a system whilst allowing the addition of customised monitoring modules to such a system.

### SUMMARY OF THE INVENTION

According to one aspect of the invention there is provided a method of monitoring processes on one or more general purpose computers, said method comprising:
providing a host data processing module;
adaptively updating the host module with one or more additional data processing modules; and
processing a document comprising a plurality of separate data portions, said data portions being intended for processing by different data processing modules, the document processing comprising parsing the document in accordance with a plurality of rules so as to validate the document,
wherein the method comprises retrieving a subset of rules, in respect of at least one said data processing module, and building said plurality of rules from said subset.

Each adaptable data processing module thus performs some processing (e.g. of a task) in accordance with a different portion of the validated document. Since these data portions are embedded within a single document, an advantage of embodiments of the invention is that a single document can be sent and/or stored on behalf of and/or processed by the plurality of data processing modules, thereby increasing efficiency of processing and network resource utilisation.

In at least one embodiment of the invention the plurality of rules is embodied in a schema and each subset of rules is provided by a sub-schema. In one arrangement the document, schema and sub-schema are specified using the eXtensible Mark-up Language (XML), thus enabling the document to conveniently include a reference to the plurality of rules intended to be used for parsing this document. The reference is identified during the parsing of the document, which means that the rules used to validate the document are explicitly linked to the document itself.

Conveniently the method includes holding a framework for the plurality of rules, and building said plurality of rules using a structure specified by said framework. In the case where the plurality of rules is a schema, the framework may be a schema wrapper.

Further objects, advantages and features of the invention will be apparent from the following more particular description of preferred embodiments of the invention, as illustrated in the accompanying drawings.

### BRIEF DESCRIPTION OF DRAWINGS

FIG. 1 is a schematic illustration of components of a network monitoring system, in accordance with an embodiment of the invention;

FIG. 2 is a schematic illustration of software components in a monitoring agent for a general-purpose computer, in accordance with an embodiment of the invention;

FIG. 3 is a schematic illustration of software modules for a general-purpose computer and a control console in accordance with an embodiment of the invention;

FIG. 4 is a flow diagram showing processing carried out during document processing in accordance with an embodiment of the invention;

FIG. 5 is a schematic illustration of a first type of schema built in accordance with an embodiment of the invention; and

FIG. 6 is a schematic illustration of a second type of schema built in accordance with an embodiment of the invention.

### DETAILED DESCRIPTION OF PREFERRED EMBODIMENTS

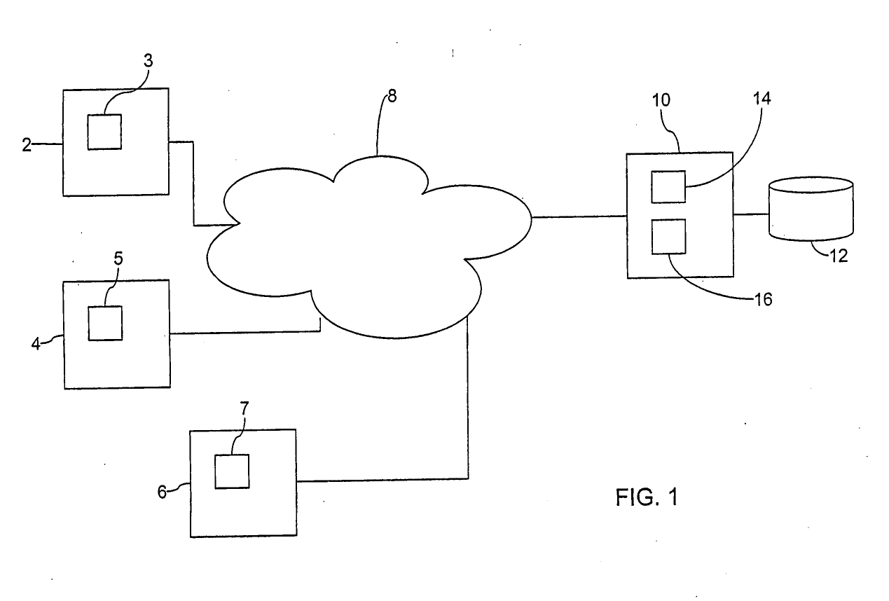

Referring now to FIG. 1, in accordance with one embodiment of the invention, a data processing system includes a monitoring software platform installed on a plurality of general-purpose computers 2, 4, 6 connected via a data communications network 8 to a common control unit 10. The data communications network 8 may take the form of a private network, a public network (such as the Internet), or a virtual private network.

The general purpose computers, referred to hereinafter as user stations, may be in the form of conventional personal computers running applications on a native operating system, such as Microsoft Windows™ or may be network servers, such as Citrix™ servers, providing the resources to thin client workstations (not shown) to run application sessions on their behalf, or may take the form of other types of data processing device such as handheld devices including personal digital assistants (PDAs), smartphones, etc. The user stations 2, 4, 6 each have user software applications installed thereon, such as word processing software, web browser applications, e-mail applications, image processing applications, and various other types of known user applications which are executed on the user stations in response on start-up of the user station, or when selected by the user from an initialisation menu provided by the user station. Each user station 2, 4, 6 also includes a monitoring software platform application in the form of an adaptable monitoring agent 3, 5, 7 installed thereon, to be described below in further detail.

The control unit 10, which may for example take the form of a network server with an associated management terminal (not shown) is provided with a database 12 for storing data sent to the console 10 by each of the monitoring agents 3, 5, 7. The control unit also includes monitoring software platform applications in the form of a control console 14, to be described in further detail below, and a reporting console 16 installed thereon. Note that the functions of the control unit may be distributed over a plurality of physical data processing units, which may be located remote from one another and connected via network links. The control console 14 interoperates with the monitoring agents 3, 5, 7 under the instruction of a network administrator to retrieve selected monitoring data from the user stations 2, 4, 6 and to input the data into the database 12. The reporting console 16 is used by the network administrator to present and manipulate the monitoring data and to generate summary reports derived from the monitoring data using in-built processing, manipulation and reporting functions.

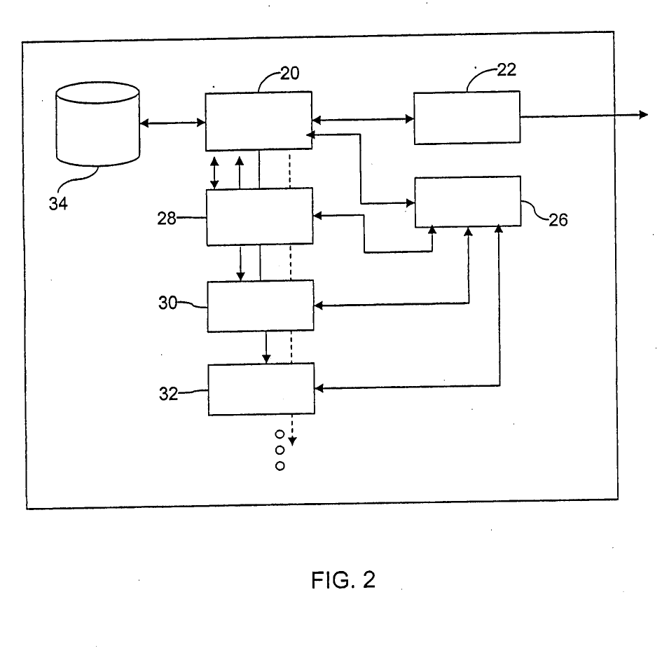

Each monitoring agent 3, 5 7 includes a plurality of components, of which relevant components are shown in FIG. 2. An agent host object 20 has a coordinating function, whereby documents containing data to be shared between other modules of the agent are processed and distributed, and whereby data are collected from the other modules for the purpose of collecting and storing persistent state, held in local state store 34 (which is part of the local storage capabilities of the user station; it may for example form part of a hard drive storage medium provided in the user station) and for posting collected monitoring data to the control unit 10. A communications module 22 handles the delivery of information to and from the control unit 10. A scheduler module 26 takes schedule information from the agent host 20, which is in turn received from the console 14, and builds a schedule that is used to trigger events in the agent, such as initialising a module and instructing the module to carry out a specified monitoring task at scheduled date/times, and triggering the posting of monitoring data to the console 14 at scheduled date/times. A first plugin monitoring module 28 carries out specified monitoring tasks relating to the hardware components of the user station, under the control of scheduler 26 and agent host 20. A second plugin monitoring module 30 carries out specified monitoring tasks relating to the user software applications installed on the user station, under the control of scheduler 26 and agent host 20. A third plugin monitoring module 32 carries out further specified monitoring tasks relating to user station, under the control of scheduler 26 and agent host 20. The plugin monitoring modules 28, 30, 32 are examples of a plurality of customised plugin modules that may be installed on the user station by the network administrator, using console 14, to adapt the agent to specific monitoring. The plugin monitoring module(s) may be written by the platform developer or a third party developer using an application programming interface (API) provided with the monitoring software platform, whereby the generic control functions, such as the scheduling and communications functions, of the platform are reused. Thus, while only three plugin monitoring modules are described herein, it should be understood that the agent may include more such modules, and that any such modules may be added, or removed, at a time after installation of the monitoring software platform as and when desired by the network administrator.

When instructed by the network administrator to transmit configuration data and/or software updates to an agent on a user station 2, 4, 6, the console 14 generates a broadcast document, structured as an XML document, containing a plurality of document portions for processing and distribution to various of the different agent modules by the agent host 20. When storing persistent state in the form of configuration data for various of the different agent modules, the agent host 20 generates a configuration document containing a plurality of document portions containing configuration data from various of the different agent modules and stores the same in local state store 34, for subsequent processing and redistribution to the different agent modules by the agent host. This is carried out for example periodically and/or during the shut down procedures for the user station. When posting monitoring data to the console, agent host 20 generates a session document containing a plurality of document portions containing monitoring data from several of the different agent modules, and posts the document to the console 14 via communications module 22. This is carried out at scheduled date/times, preferably during relatively inactive periods of network usage (e.g. around midnight).

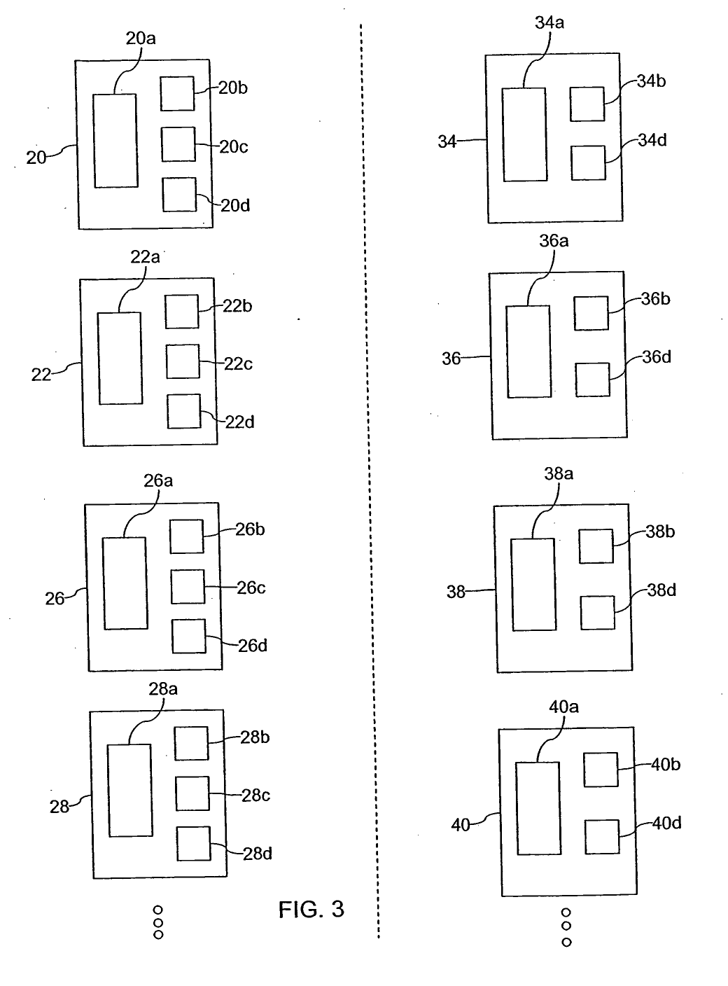

An embodiment of the invention will now be described in more detail, with reference to FIG. 3, which illustrates several of the agent modules 20, 22, 26, 28 as installed in one of the monitoring agents 3, 5, 7, along with counterpart modules 34, 36, 38, 40 installed in the control console 14. The console modules include a console host 34, a console communications module 36, a console scheduler module 38, and a console plugin module 40. The counterpart modules construct document portions for transmission to respective agent modules on each user station 2, 4, 6, under the control of rules in the console 14, and instructions received from the network administrator, and are used to validate respective document portions received from respective agent modules on each user station 2, 4, 6, and process the received monitoring data for storage in database 12.

Each agent module 20, 22, 26, 28 includes a software code part, labelled 20a; 22a; etc., defining the functions carried out by the module when executed, and schema portions, respectively labelled 20b, 20c, 20d; 22b, 22c, 22d; etc., and the agent host 20 performs validation of documents when received for processing thereby, as will be described in further detail below. The schema portions include broadcast document schema portions, labelled 20b, 22b, etc., configuration document schema portions, labelled 20c, 22c, etc., and session document schema portions, labelled 20d, 22d, etc.

Each console module 34, 36, 38, 40 includes a software code part, labelled 34a; 36a; etc., defining the functions carried out by the module when executed, and schema portions, respectively labelled 34b, 34d; 36b, 36d; etc., and the console host 34 performs validation of documents when received for processing thereby, as will be described in further detail below. The schema portions include broadcast document schema portions, labelled 34b, 36b, etc., and session document schema portions, labelled 34d, 36d, etc.

The schema portions 20b, 20c, 20d and 34b, 34d stored in the agent host 20 and the console host 34 are referred to herein as schema wrappers. These define the structure of a schema used to validate a given type of document received by the respective host. A schema is built using the wrapper schema of the appropriate type along with sub-schemas, which are inserted into the schema wrapper, of the appropriate type. These sub-schemas are the schema portions 22b, 22c, 22d; etc., and 36b, 36d, etc. stored in the remaining agent modules.

In order to add a new plugin to any one or more of the monitoring agents 3, 5, 7, the network administrator selects an appropriate plugin module addition function on the console side, and the plugin is sent to the appropriate one or more monitoring agents 3, 5, 7 as a software update which is processed by the agent host 20. On receiving a new software update, the agent host 20 validates the received file and stores the plugin in a data store, such as a hard drive, on the user terminal 2, 4, 6. A corresponding entry, along with an identifier allowing the plugin module to be launched, is written to the registry of that user terminal 2, 4, 6 for subsequent lookup. Thus, when a new plugin module is installed in a monitoring agent, its corresponding sub-schemas are made available for incorporation in a schema built by the respective host in order to validate a document received which contains a portion including data for processing by the new plugin module (or its counterpart plugin module in the console).

Processing of Documents

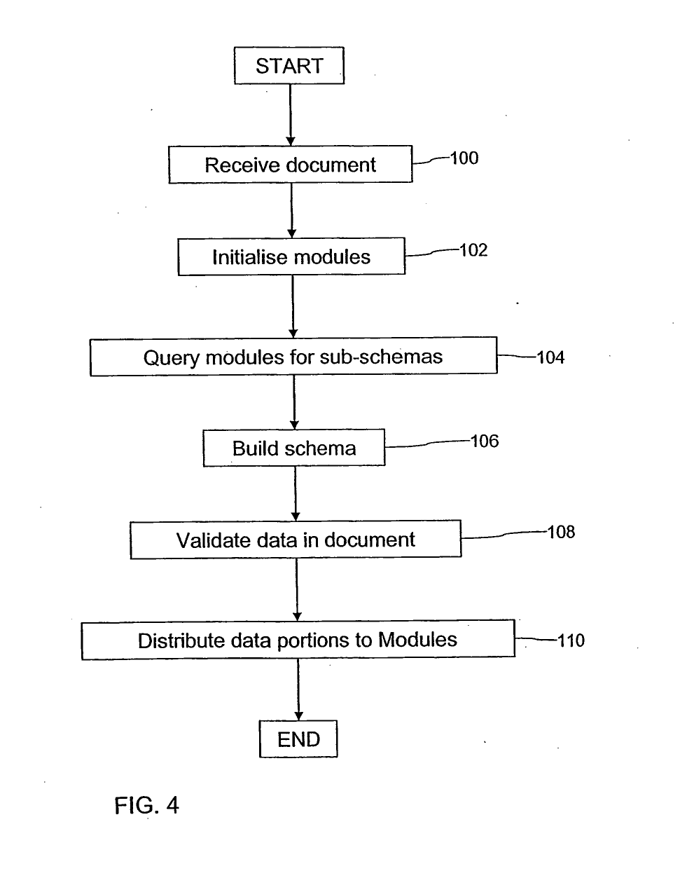

FIG. 4 shows steps carried out by the agent host 20 in order to process a received document. The document may be a broadcast document, a configuration document, or a session document (to be transmitted by the monitoring agent 3, 5, 7 to the console 14). It should be appreciated that the description hereof also applies to the console host 34 in relation to the processing of received broadcast documents (to be transmitted to one or more monitoring agents) or session documents.

Firstly in step 100, the document is received. The document may be received over the network interface or from a local function. As described above, in order to validate the received document, a schema, comprising a schema portion corresponding to the type of received document (broadcast, session, configuration) and sub-schema portions, is created. Thus, in order to create the validating schema, the agent host 20 needs to retrieve the relevant sub-schemas.

Accordingly, the agent host 20 first queries the registry of the user station on which it runs to obtain the list of entries identifying the currently stored agent platform modules and its current plugin modules. The agent host 20 then proceeds to initialise all monitoring platform modules that are not currently running in the user station, at step 102, and queries the respective modules in turn, at step 104, requesting their respective sub-schemas. After receiving their responses, the agent host 20 may transmit an instruction (not shown as a separate step) to each plugin module not currently carrying out a monitoring task to close down. Generally, the communications module 22 and the scheduler module 26 are left running along with the agent host 20 whilst the user station is operative, since their functionality may be called upon at any time. On the other hand, plugin modules are generally closed down by the scheduler module 26 after carrying out their scheduled monitoring tasks, to reduce user station resource utilisation by the monitoring system.

Once all the required sub-schemas have been retrieved, the agent host 20 uses the wrapper schema (schema portions) to build, at step 106, a schema containing the sub-schemas retrieved at step 104. This step essentially involves placing the retrieved sub-schemas from each module in a predetermined part of the wrapper. The sub-schemas can be inserted in an order corresponding to the order in which the module identities are retrieved from the registry, or in accordance with alphabetical ordering, etc. Thus, although the wrapper schema does not include actual identifying information for each plugin module, the final schema is built using input from each of the plugin modules in turn.

Once the schema is built, the agent host 20 stores the built schema in memory. To validate a document, the agent host 20 then uses a document validation function provided by a parser used by the agent host 20 to validate the entire document contents using the freshly built schema, at step 108. On validation of the document contents, the various different document portions are distributed to the respected agent modules, step 110. A similar process is carried out by the console host 34 in building up schemas for processing documents received from agent hosts across the network (e.g. session documents). Note that the schema building process may be carried out whenever a document is to be processed. More preferably, any required schemas are built on start-up of the user station or the console system, and stored for use until the station or system is shut down, or a new plugin module is loaded.

In one arrangement the document received at step 100 may be an eXtensible Mark-up Language (XML) document, while the schema created at step 106 may be an XML schema and the parser used in step 108 to validate the created schema may be an XML parser. The XML Schema standard, which is incorporated herein by reference, is a working draft of the W3C Schema Working Group. A description of this standard can be found in the document “XML Schema: Formal Description”, W3C Working Draft, 20 Mar. 2001, and a copy can be found at http://www.w3.org/TR/2001/WD-xmlschema-formal-20010320/. For the purpose of validating a document in accordance with a given XML schema (here step 108) an XML reader such as Microsoft™ XML parser version 4.0 may be used. As is known in the art, for an XML document to be validated it must inform the reader which schema should be used; accordingly the documents received at step 100 include an identifier corresponding to the schema subsequently created at step 106.

In this embodiment, there are various parts of the system where data are exchanged and/or stored, namely the broadcast document sent from the console to a monitoring agent, the local configuration document and locally-stored session history for the monitoring agent, and the document that is posted from the monitoring agent to the console. The posted document is a latest available version of the locally-stored session document; hence both the locally stored and posted session documents share the same schema. XML documents sent across the network can be compressed and encrypted to increase network transmission speeds and security.

Defining Bespoke XML Schema

The schema portions and sub-schemas used to create the schema at step 106 will now be described in more detail.

In XML documents, elements (or tags) in the documents generally have the form:
<name> . . . </name>

The content of the tag is between the ‘>’ and the ‘<’. If no content is required, then the end tag can be omitted.

Attributes appear inside the opening tag brackets, thus for example:
<:name attribute1=‘value1’ attribute2=‘value1’ . . . > . . . </:name>

Generally attributes have string values, but they can have dates, times, or any form, and they can be validated by the XML schemas used.

Element and attribute identifiers reside in namespaces. If a tag comes from a particular namespace rather than the default then it may be used as follows:
<namespace:name> . . . <namespace:name>

In order to use a namespace the namespace has to be declared, and the identifiers within a namespace must be unique.

There is a special floating attribute that can be applied anywhere within the document, but often is on the root element, setting the scene for the whole document. This attribute is “xmlns”; in any XML document, ‘xmlns’ attributes can be applied to any tag, meaning that from this point on in the XML document, the associated namespace applies. The “xmlns” attribute is used as follows:
<anytag . . . xmlns:nnn=‘mmm’ . . . >
where ‘mmm’ is the full name of the namespace and ‘nnn’ is a shortened namespace name that is used within a document instance to indicate which XML Schema an element belongs to. The ‘nnn’ part can be null, in which case the schema is opened up into the default namespace.

The XML standard (referenced above) defines a standard schema that controls the structure of an XML schema document; for a document to make use of that schema, the document contents must request its associated namespace to be made available. This is achieved by including the following in the XML file:
xmins:xsd=“http.//www.w3.org/2001/XMLSchema”

This firstly requests the use of a namespace (xmlns), secondly states that it is to be aliased as the ‘xsd’ (:xsd) namespace, and thirdly defines the namespace as ‘http://www.w3.org/2001/XMLSchema’ (which is a URI (Uniform Resource Identifier)). By including this schema in the namespace, further schemas may be defined using standard tags that will be understood by an XML compliant engine and interpret the file as an XML schema file.

Further, bespoke schemas, can be defined by including a further “xmins” reference in the XML file:
xmlns=“monactive:agentbroadcast”

In this example, the xmlns reference comprises three levels: the word ‘monactive’ defines the root of a namespace tree; the second level indicates that the entity using the schema is to be a monitoring agent; and the third level indicates the use for which the monitoring agent is going to put the document (in this example broadcast use).

In this embodiment there are three uses; broadcast, configuration and session, i.e. ‘broadcast’, ‘config’ and ‘session’, and there are therefore three namespaces:
monactive:agent:broadcast
monactive:agent:config
monactive:agent:sessions

Thus, in an exemplary document, the top-level tag and the attributes associated therewith could comprise:
<xsd:schema targetNamespace=“monactive:agent:broadcast” . . . > . . . </xsd:schema>

The ‘schema’ tag from the ‘xsd’ namespace, with a “targetNamespace” attribute having a value ‘monactive:agent:broadcast’ informs the XML parser that an XML schema is being defined, and that the name of the schema is specified in attribute “targetNamespace” (i.e. monactive:agent:broadcast)

Because of the adaptability of the monitoring agents by means of the addition (and/or removal) of plugin modules, the present invention provides a system whereby a schema can be both known in order to validate the documents, but unknown, such that a module can change its own portion of a schema while no other module knows about, or relies on, anything inside it. In order to allow a flexible architecture, the present invention employs what is referred to herein as a ‘wrapper schema’, which at the highest level sets out an overall structure of a schema, and ‘sub-schemas’ which are inserted into the wrapper and are defined by each module defines in accordance with a set of rules.

There are two general forms for the schemas used, namely “flat” and “block” structured.

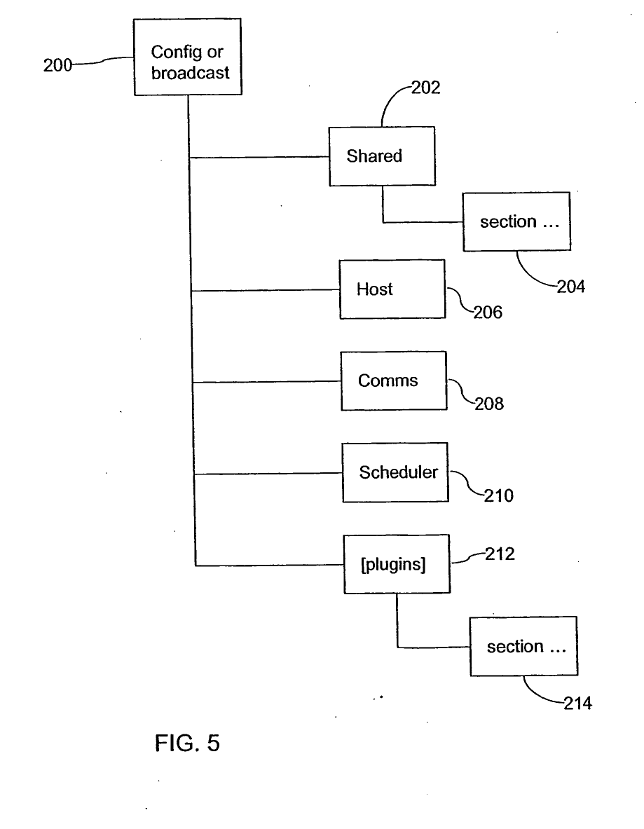

FIG. 5 illustrates an example of a “flat” structured schema created at step 106 by the agent host 20 or the console host 34. The configuration and broadcast schemas follow this general form. The structure of the built schema includes a top level part 200 derived from a broadcast or config wrapper schema. The next level down includes a shared part 202 derived from a shared sub-schema, including a section part 204 in the next level of the hierarchy, a host part 206 derived from a host sub-schema, a comms part 208 derived from a comms sub-schema 208, a scheduler part 210 derived from a scheduler sub-schema, and one or more plugin parts 212 (only one is shown in FIG. 5) corresponding to each plugin module and derived from each respective submodule schema. Each plugin part may include a section part 214 structured in the same manner as the section part 204 appearing in the shared part 202.

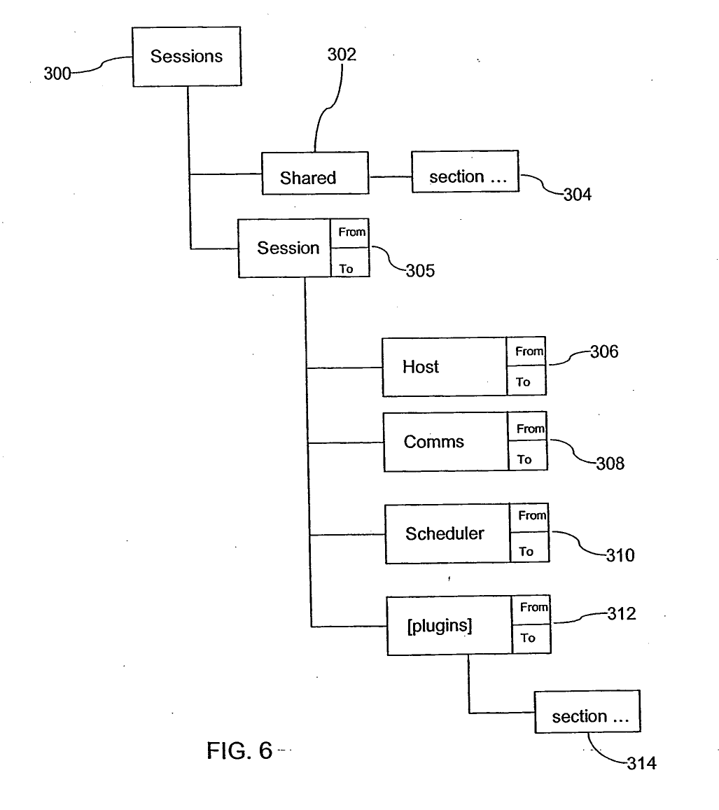

FIG. 6 illustrates an example of a “block” structured schema created at step 106 by the agent host 20 or the console host 34. The session schema follows this general form. Each module can write its own session data many times in the same agent session. Over time a module will write many sessions to the agent host, and the agent host will gather up these module sessions into one agent session, essentially grouped in accordance with the time they were written to the agent host. Thus, each block part includes a description of the time period over which the session data were collected. The structure of the built schema includes a top level part 300 derived from a session wrapper schema. The next level down includes a shared part 302 derived from a shared sub-schema, including a section part 304 in the next level of the hierarchy, and a session part 305 having in the next level of the heirarchy a host part 306 derived from a host sub-schema, a comms part 308 derived from a comms sub-schema 308, a scheduler part 310 derived from a scheduler sub-schema, and one or more plugin parts 312 (only one is shown in FIG. 6) corresponding to each plugin module and derived from each respective submodule schema. Each plugin part may include a section part 314 structured in the same manner as the section part 304 appearing in the shared part 302.

The following section gives examples of broadcast, configuration and session wrapper schemas created at step 106 in accordance with their respective schema wrappers. The short namespace aliases used are “mab”, “mac” and “mas”, respectively.

First, an example of a broadcast wrapper schema:

WRAPPER SCHEMA 1 (broadcast)

<?xml version=“1.0” encoding=“UTF-8”?>

<xsd:schema targetNamespace=“monactive:agent:broadcast”

xmlns=“monactive:agent:broadcast”
xmlns:xsd=“http://www.w3.org/2001/XMLSchema”>

| | |
|---|---|
| <xsd:element name=“broadcast”> | 200 |

<xsd:complexType>

<xsd:all>

| | |
|---|---|
| <xsd:element ref=“shared” minOccurs=“1” axOccurs=“1”/> | 202 |
| <xsd:element ref=“host” minOccurs=“1” maxOccurs=“1”/> | 206 |
| <xsd:element ref=“comms” minOccurs=“1” maxOccurs=“1”/> | 208 |
| <xsd:element ref=“scheduler” minOccurs=“1” maxOccurs=“1”/> | 210 |
| ... | 212 |

</xsd:all>
<xsd:attribute name=“checksum” use=“required”>

<xsd:simpleType>

<xsd:restriction base=“xsd:string”>

<xsd:pattern value=“[0-9A-F]{8}”/>

</xsd:restriction

</xsd:simpleType>

</xsd:attribute>

</xsd:complexType>

</xsd:element>
...

</xsd:schema>

Note that the element ref section in the middle of wrapper schema 1 comprises an ellipsis. This section is assembled by the agent or console host polling all the remaining plugin modules (in other words, this section comprises data corresponding to the sub-schemas retrieved at step 104). The same applies in relation to each of the configuration and session wrapper schemas.

Next, an example of a configuration schema wrapper:

WRAPPER SCHEMA 2 (configuration)

<?xml version=“1.0” encoding=“UTF-8”?>

<xsd:schema targetNamespace=“monactive:agent:config”

xmlns=“monactive:agent:config”
xmlns:xsd=“http://www.w3.org/2001/XMLSchema”>

<xsd:element name=“config”>

<xsd:complexType>

<xsd:all>

<xsd:element ref=“shared” minOccurs=“0” maxOccurs=“1”/>
<xsd:element ref=“host” minOccurs=“0” maxOccurs=“1”/>
<xsd:element ref=“comms” minOccurs=“0” maxOccurs=“1”/>
<xsd:element ref=“scheduler” minOccurs=“0” maxOccurs=“1”/>
...

</xsd:all>
<xsd:attribute name=“checksum” use=“required”>

<xsd:simpleType>

<xsd:restriction base=“xsd:string”>

<xsd:pattern value=“[0-9A-F]{8}”/>

</xsd:restriction>

</xsd:simpleType>

</xsd:attribute>

</xsd:complexType>

</xsd:element>
...

</xsd:schema>

Next, an example of a session wrapper schema:

WRAPPER SCHEMA 3 (session)

<?xml version=“1.0” encoding=“UTF-8”?>

<xsd:schema targetNamespace=“monactive:agent:sessions”

xmlns=“monactive:agent:sessions”
mlns:xsd=“http://www.w3.org/2001/XMLSchema”>

| <xsd:attribute name=“from” type=‘xsd:dateTime’/> | |
|---|---|
| <xsd:attribute name=“to” type=‘xsd:dateTime’/> | |
| <xsd:element name=“sessions”> | 300 |

<xsd:complexType>

<xsd:choice minOccurs=‘0’ maxOccurs=‘unbounded’>

| | |
|---|---|
| <xsd:element ref=“shared” minOccurs=“0”/> | 302 |
| <xsd:element ref=“session” minOccurs=“0” maxOccurs=“unbounded”/> | 305 |

</xsd:choice>
<xsd:attribute name=“checksum” use=“required”>

<xsd:simpleType>

<xsd:restriction base=“xsd:string”>

<xsd:pattern value=“[0-9A-F]{8}”/>

</xsd:restriction>

</xsd:simpleType>

</xsd:attribute>

</xsd:complexType>

</xsd:element>
<xsd:element name=‘session’>

<xsd:complexType>

<xsd:choice minOccurs=‘0’ maxOccurs=‘unbounded’>

| | |
|---|---|
| <xsd:element ref=“host” minOccurs=“0” maxOccurs=“unbounded”/> | 306 |
| <xsd:element ref=“comms” minOccurs=“0” maxOccurs=“unbounded”/> | 308 |
| <xsd:element ref=“scheduler” minOccurs=“0” maxOccurs=“unbounded”/> | 310 |
| ... | 312 |

</xsd:choice>
<xsd:attribute ref=“from” use=“required”/>
<xsd:attribute ref=“to” use=“optional”/>

</xsd:complexType>

</xsd:element>
...

</xsd:schema>

All three wrapper schemas above refer to a shared area into which standard form data can be stored:
<xsd:element ref=“shared” minOccurs=“0”/>

Referring to the shared sub-schema set out below, in the shared area, simple text strings scan be stored in an entry section. A string is given an “id” which is used to refer to it (see parts in italics). A group of text strings can be related together using a relation section and optionally associated with another text string. A hierarchical construct can be represented as a string divided into substrings by a divider, and the substrings connected together using the “id” and a parent id (“pid” . . . see parts in italics).

SHARED SUBSCHEMA

<!-- shared subschema for any ancestor −−>

| | |
|---|---|
| <xsd:element name=“shared”> | 202, 302 |

<xsd:complexType>

<xsd:sequence>

<xsd:element ref=‘section’ minOccurs=“0” maxOccurs=“unbounded”/>

</xsd:sequence>

</xsd:complexType>

</xsd:element>

| | |
|---|---|
| <xsd:element name=“section”> | 204, 214, 304, 314 |

<xsd:complexType>

<xsd:choice>

<xsd:element name=“entry” maxOccurs=“unbounded”>

<xsd:complexType>

<xsd:attribute name=“id” type=“xsd:ID”/>
<xsd:attribute name=“string” type=“xsd:string”/>

</xsd:complexType>

</xsd:element>
<xsd:element name=“heir” maxOccurs=“unbounded”>

<xsd:complexType>

<xsd:attribute name=“id” type=“xsd:ID”/>
<xsd:attribute name=“pid” type=“xsd:string” default=‘˜’/>
<xsd:attribute name=“string” type=“xsd:string”/>

</xsd:complexType>

</xsd:element>
<xsd:element name=“rel” maxOccurs=“unbounded”>

<xsd:complexType>

<xsd:attribute name=“id” type=“xsd:ID” use=“required”/>
<xsd:attribute name=“ids” type=“xsd:IDREFS” use=“required”/>
<xsd:attribute name=“string” type=“xsd:string” use=“optional”/>

</xsd:complexType>

</xsd:element>

</xsd:choice>
<xsd:attribute name=“title” type=“xsd:string” use=“required”/>
<xsd:attribute name=“nextid” type=“xsd:string” use=“optional”/>
<xsd:attribute name=“divider” type=“xsd:string” use=“optional”/>

</xsd:complexType>

</xsd:element> ...

These “entry” tags allow, in the XML document being validated, storage of a simple string of text associated with an “id” that may be referred to later in the document, while “heir” tags allow storage of hierarchical strings, like paths or URLs. An “id” is associated with a string, “parented” refers to another “heir” that belongs in front of this string in the hierarchy being modelled. A “rel” tag allows any “IDREF”s to be related together as attribute “id”s and optionally bound to another string. The “IDREF”s and the string form a unique pair.

The following section gives examples of subschemas stored by the agent host module which are inserted into the wrapper schema at the appropriate position (e.g. referring back to Wrapper schema 1, occurrence of <xsd:element ref=“host” minOccurs=“1” MaxOccurs=“1”/> causes the following instance of the host subschema to be inserted into the wrapper).

Firstly an example of the host subschema corresponding to the broadcast wrapper schema is presented:

HOST SUBSCHEMA 1 (broadcast)

...

<xsd:element name=“host”>

<xsd:complexType>

<xsd:all>

<xsd:element name=“upgrade” minOccurs=“0” maxOccurs=‘1’>

<xsd:complexType>

<xsd:sequence>

<xsd:element name=“module”>

<xsd:complexType>

<xsd:attribute name=“type” use=“required”>

<xsd:simpleType>

<xsd:restriction base=“xsd:string”>

<xsd:enumeration value=“exe”/>
<xsd:enumeration value=“service”/>
<xsd:enumeration value=“host”/>
<xsd:enumeration value=“comms”/>
<xsd:enumeration value=“plugin”/>

</xsd:restriction>

</xsd:simpleType>

</xsd:attribute>
<xsd:attribute name=“name” type=“xsd:string” use=“required”/>
<xsd:attribute name=“remote_filename” type=“xsd:string”

use=“required”/>

<xsd:attribute name=“local_filename” type=“xsd:string”

use=“required”/>

</xsd:complexType>

</xsd:element>

</xsd:sequence>

</xsd:complexType>

</xsd:element>

</xsd:all>

</xsd:complexType>

</xsd:element>
...

The “upgrade” element is an optional element in a broadcast document. It lists the new modules to download, what the name is (which also identifies what other plugin sections there are in the schema), where they are located (remote_filename) and what they should be called locally (local_filename).

Next, an example of a host subschema corresponding to a session wrapper schema:

HOST SUBSCHEMA 2 (session)

...

<xsd:element name=“host”>

<xsd:complexType>

<xsd:all>
</xsd:all>

</xsd:complexType>

</xsd:element>
...

In the following section, examples are given of communications module subschemas. First, an example of a communications module subschema corresponding to the broadcast schema wrapper:

COMMS SUBSCHEMA 1 (broadcast)

<xsd:element name=“comms”>

<xsd:complexType>

<xsd:all>

<xsd:element name=‘utcserver’>

<xsd:simpleType>

<xsd:restriction base=‘xsd:string’>

<xsd:pattern value=“([0-9]{1,3}\.[0-9]{1,3}\.[0-9]{1,3}\.[0-9]{1,3})|([a-zA-

Z0-9_][a-zA-Z0-9_.]+)”/>

</xsd:restriction>

</xsd:simpleType>

</xsd:element>

</xsd:all>

</xsd:complexType>

</xsd:element>???

Next, an example of a communications subschema corresponding to a configuration schema wrapper:

COMMS SUBSCHEMA 2 (configuration)

<xsd:element name=“comms”>

<xsd:complexType>

<xsd:all>

<xsd:element name=‘utcserver’>

<xsd:simpleType>

<xsd:restriction base=‘xsd:string’>

<xsd:pattern value=“([0-9]{1,3}\.[0-9]{1,3}\.[0-9]{1,3}\.[0-9]{1,3})|([a-zA-

Z0-9_][a-zA-Z0-9_.]+)”/>

</xsd:restriction>

</xsd:simpleType>

</xsd:element>
<xsd:element name=“broadcast”>

<xsd:complexType>

<xsd:attribute name=‘general-modified-at’ type=‘xsd:datetime’/>
<xsd:attribute name=‘specific-modified-at’ type=‘xsd:datetime’/>

</xsd:complexType>

</xsd:element>

</xsd:all>

</xsd:complexType>

</xsd:element>???

Next, an example of a communications subschema corresponding to a session schema wrapper:

COMMS SUBSCHEMA 3 (session)

<xsd:element name=“comms”>

<xsd:complexType>

<xsd:all/>

<xsd:attribute name=‘from’ type=‘xsd:dateTime’/>
<xsd:attribute name=‘to’ type=‘xsd:dateTime’/>

</xsd:complexType>

</xsd:element>

In the following section, an example of a general form and specific subschema variants are given of scheduler module subschemas. Firstly an example of the general form is as follows:

SCHEDULER SUBSCHEMA 1 (general)

<xsd:element name=“scheduler”>

<xsd:complexType>

<xsd:all>

<xsd:element name=“schedule”>

<xsd:complexType>

<xsd:sequence>

<xsd:element name=“at” minOccurs=“0” maxOccurs=“unbounded”>

<xsd:complexType>

<xsd:sequence>

<xsd:element name=“module”>

<xsd:complexType>

<xsd:attribute name=“name” type=“xsd:IDREF”

use=“required”/>

<xsd:attribute name=“event” type=“xsd:string”

use=“required”/>

</xsd:complexType>

</xsd:element>

</xsd:sequence>
<xsd:attribute name=“when” use=“required”>

<xsd:simpleType>

<xsd:restriction base=“xsd:string”>

<xsd:pattern value=
“[@+](20[0-9]{2})?([01*][0-9*])?([0123*][0-9*])?([0-

2*][0-9*])?([0-9][0-9])?U?”/>

</xsd:restriction>

</xsd:simpleType>

</xsd:attribute>
<xsd:attribute name=“lastranutc” use=“optional” default=“2001-01-

01T00:00:00”>

<xsd:simpleType>

<xsd:restriction base=“xsd:dateTime”>

<xsd:mininclusive value=“2001-01-

01T00:00:00”/>

</xsd:restriction>

</xsd:simpleType>

</xsd:attribute>

</xsd:complexType>

</xsd:element>

</xsd:sequence>
<xsd:attribute name=“mode” use=“required”>

<xsd:simpleType>

<xsd:restriction base=“xsd:string”>

<xsd:enumeration value=“replace”/>
<xsd:enumeration value=“append”/>

</xsd:restriction>

</xsd:simpleType>

</xsd:attribute>

</xsd:complexType>

</xsd:element>

</xsd:all>

</xsd:complexType>

</xsd:element>

For the broadcast subschema variant, the most important information that the scheduler section conveys is the schedule itself. This defines which events happen to named modules at what time.

For the configuration subschema variant, the schedule element will define what events are to be fired on which objects at which time.

The plugin module subschemas will follow a similar pattern as the existing host, communications and scheduler subschemas.

In the following section, examples are given of documents structured in accordance with the schemas defined above. Firstly an example of a broadcast document:

BROADCAST DOCUMENT

<?xml version=“1.0” encoding=“UTF-8”?>

<mab:broadcast xmlns:mab=“monactive:agent:broadcast”

xmlns:xsi=“http://www.w3.org/2001/XMLSchema-instance”
xsi:schemaLocation=“monactive:agent:broadcast

E:\ss\proj\martini\wrapper\broadcast.xsd”

checksum=‘01234567’>

<mab:shared>

<section title=“path”>

<heir id=“p1” string=“c:\wibble\wobble”/>
<heir id=“p2” string=“c:\wibble\wibble”/>

</section>
<section title=“file”>

<entry id=“f1” string=“file1.exe”/>
<entry id=“f2” string=“file2.exe”/>

</section>
<section title=“apps”>

<rel id=“a1” ids=“p2 f1” string=“groovy program”/>
<rel id=“a2” ids=“p1 f2” string=“another groovy program”/>

</section>

</mab:shared>
<mab:host>

<upgrade>

<module name=‘comms’ type=‘comms’ remote_filename=‘abc.def’

local_filename=‘macomms.dll’>

</upgrade>
<run mode=‘replace’>

<module name=“citrix”/>

</run>

</mab:host>
<mac:comms>

<utcserver>hogthrob</utcserver>

</mac:comms>
<mab:scheduler>

<schedule mode=‘replace’>

<at when=“+15” lastranutc=“2001-01-01T00:00:00”>

<module name=“citrix” event=“checksessions”/>

</at>

</schedule>

</mab:scheduler>

</mab:broadcast>

Next, an example of a configuration document:

CONFIGURATION DOCUMENT

<?xml version=“1.0” encoding=“UTF-8”?>

<mac:config xmlns:mac=“monactive:agent:config”

xmlns:xsi=“http://www.w3.org/2001/XMLSchema-instance”
xsi:schemaLocation=“monactive:agent:config E:\ss\proj\martini\wrapper\config.xsd”
checksum=‘01234567’>

<mac:shared>

<section title=“path”>

<heir id=“p1” string=“c:\wibble\wobble”/>

<heir id=“p2” string=“c:\wibble\wibble”/>

</section>
<section title=“file”>

<entry id=“f1” string=“file1.exe”/>

<entry id=“f2” string=“file2.exe”/>

</section>
<section title=“apps”>

<rel id=“a1” ids=“p2 f1” string=“groovy program”/>
<rel id=“a2” ids=“p1 f2” string=“another groovy program”/>

</section>

</mac:shared>
<mac:host/>
<mac:comms>

<utcserver>hogthrob</utcserver>
<broadcast general-modified-at=‘2001-11-14T11:23’ specific-modified-at=‘2001-11-

14T11:23’/>

</mac:comms>
<mac:scheduler>

<schedule>

<at when=“+15” lastranutc=“2001-01-01T00:00:00”>

<module name=“citrix” event=“checksessions”/>

</at>

</schedule>

</mac:scheduler>

</mac:config>

Next, an example of a session document:

SESSION DOCUMENT

<?xml version=“1.0” encoding=“UTF-8”?>

<mas:session xmlns:mas=“monactive:agent:session”

xmlns:xsi=“http://www.w3.org/2001/XMLSchema-instance”
xsi:schemaLocation=“monactive:agent:session E:\ss\proj\martini\wrapper\session.xsd”
checksum=‘01234567’>

<mas:shared>

<section title=“path”>

<heir id=“p1” string=“c:\wibble\wobble”/>
<heir id=“p2” string=“c:\wibble\wibble”/>

</section>
<section title=“file”>

<entry id=“f1” string=“file1.exe”/>
<entry id=“f2” string=“file2.exe”/>

</section>
<section title=“apps”>

<rel id=“a1” ids=“p2 f1” string=“groovy program”/>
<rel id=“a2” ids=“p1 f2” string=“another groovy program”/>

</section>

</mas:shared>

<mas:session mas:from=‘2002-02-10T12:00:00’ mas:to=‘2002-02-10T13:00:00’>

<mas:host>

<pc domain=‘wibble’ hostname=‘wobble’ ip=‘123.321.231.312’

mac=‘a9b98ed8c729f9d8c’/>

</mas:host>

</mas:session>

</mas:session>

Whilst the above description gives specific examples of embodiments of the invention, it should be noted that the invention is not limited to the embodiments of the invention set out above; further embodiments of the invention are envisaged. For example, in addition to or instead of the monitoring functions described, agent modules may conduct control functions in relation to the user stations, namely instead of passively monitoring the functioning of the user station, the modules may be used to install user software, alter settings, remove undesirable software, etc. on the user station.

Note also, that whilst the above described embodiment uses the XML standard to structure documents, other forms of structuring files or documents may also be used. For example, a proprietary structuring format may be used in place of the XML standard.

Further modifications are also envisaged which fall within the scope of the invention, as set out in the accompanying claims.

1. A method of monitoring processes on one or more general purpose computers, said method comprising:
providing a host data processing module;
adaptively updating the host module with one or more additional data processing modules; and
processing a document comprising a plurality of separate data portions, said data portions being intended for processing by different data processing modules, the document processing comprising parsing the document in accordance with a plurality of rules so as to validate the document,
wherein the method comprises retrieving a subset of rules, in respect of at least one said data processing module, and building said plurality of rules from said subset.

2. A method according to claim 1, comprising holding a framework for the plurality of rules, and building said plurality of rules using a structure specified by said framework.

3. A method according to claim 1, wherein said document includes a reference to the plurality of rules, the reference being identified during the parsing of the document.

4. A method according to claim 1, wherein said document is a mark-up structured document.

5. A method according to claim 1, comprising holding said subset of rules in association with said data processing modules, and retrieving said subset of rules by processing said data processing modules.

6. A method according to claim 1, comprising receiving said document from a data processing device across a data communications network.

7. A method according to claim 6, comprising receiving said document from a common processing device at one of a plurality of similar data processing devices in the network.

8. A method according to claim 7, comprising receiving said document at each of said plurality of similar data processing devices and processing the document in each of said similar data processing devices.

9. A method according to claim 7, wherein said document comprises configuration data for configuring the operating parameters of one or more of said plurality of modules.

10. A method according to claim 9, wherein said document comprises a data relating to a new data processing module to be installed on said one or more similar data processing devices.

11. A method according to claim 10, comprising installing said new data processing module on said one or more similar data processing devices.

12. A method according to claim 1 1, comprising receiving a further document comprising a plurality of separate data portions, said data portions being intended for processing by different data processing modules including said new data processing module, the method comprising parsing the document using a further plurality of rules for validating the further document, wherein the method comprises retrieving, for said new data processing module, a new subset of rules, and building said further plurality of rules using said new subset.

13. A method according to claim 6, comprising receiving said document from one of a plurality of similar data processing devices at a common processing device.

14. A method according to claim 13, comprising generating a report including data from each of said similar data processing devices.

15. A method according to claim 1, comprising processing said document at a data processing device, and retrieving said document from storage local to said data processing device.

16. A method according to claim 1, wherein said data processing modules comprise one or more modules for monitoring usage of software resources in a data processing system.

17. A method according to claim 16, wherein said data processing modules comprise one or more modules for monitoring usage of hardware resources in a data processing system.

18. A method according to claim 1, wherein said data processing modules comprise one or more modules for detecting and recording software modules installed in a data processing system.

19. A method according to claim 1, in which the plurality of rules is provided by a schema and the subset of rules is provided by a subschema.

20. A method according to claim 19, in which the framework comprises a wrapper schema, and said schema is built using a structure specified by said wrapper schema.

21. Computer software adapted to carry out the method of claim 1.

22. A data processing system adapted to carry out the method of claim 1.

23. A method of monitoring processes on one or more general purpose computers, said process comprising providing a host data processing module and adaptively updating the host module with one or more additional data processing modules, the method comprising processing a document comprising a plurality of separate data portions, said data portions being intended for processing by different data processing modules, the method comprising parsing the document using a schema for validating the contents of the document, wherein the method comprises retrieving, for each of said data processing modules, a subschema, and building said schema from said subschemas.

24. A general purpose computer including
a data processing module;
a document processing system arranged to process a document comprising a plurality of separate data portions, at least one of said data portions being intended for processing by said data processing module, the document processing system being arranged to retrieve a subset of rules in respect of the data processing module and to parse the document in accordance with a plurality of rules so as to validate the document,
wherein the document processing system is arranged to build said plurality of rules from said retrieved subset.

25. A general purpose computer according to claim 24, including
a data receiver arranged to receive data comprising one or more additional data processing modules; and
a data installation system arranged to install data processing modules in accordance with data received corresponding thereto,
wherein, in the event that any of the plurality of data portions corresponds to one or more said additional data processing modules, the data processing system is arranged to retrieve corresponding one or more subsets of rules and to build the plurality of rules from the or each retrieved subset of rules.

26. Computer software adapted to run on general purpose computers comprising one or more data processing modules, the software being adapted to carry out the following steps:
receiving a document comprising a plurality of separate data portions, at least one of said data portions being intended for processing by said data processing module;
retrieving a subset of rules in respect of the or each data processing module;
creating a plurality of rules for parsing the received document, the plurality of rules including said retrieved subset of rules;
parsing the document in accordance with a plurality of rules so as to validate the document; and
processing said parsed document.

27. A method according to claim 2, wherein said document includes a reference to the plurality of rules, the reference being identified during the parsing of the document.

28. A method according to claim 2, wherein said document is a mark-up structured document.

29. A method according to claim 8, wherein said document comprises configuration data for configuring the operating parameters of one or more of said plurality of modules.
